(19) United States
(12) Patent Application Publication
(10) Pub. No.: US 2016/0063047 A1
(43) Pub. Date: Mar. 3, 2016

(54) Method and Apparatus for Providing a Data Manipulation Framework

(71) Applicant: McKesson Financial Holdings, Hamilton (BM)

(72) Inventor: Rick Spates, Canton, GA (US)

(21) Appl. No.: 14/473,068

(22) Filed: Aug. 29, 2014

(51) Int. Cl. G06F 17/30

(52) U.S. Cl. CPC G06F 17/30345; G06F 17/30306

(57) ABSTRACT

A method, apparatus and computer program product are provided in order to provide framework for evaluation of expressions on data sets. An example of the method includes generating a first framework object from a set of input data. The first framework object includes a first set of data values and a set of structure data defining at least one dimension for formatting the first set of data values. The first framework object is associated with a set of functions for manipulating the first set of data values. The method also includes determining an expression to be performed on the first framework object. The expression includes at least one operator. The method also includes selecting at least one of the set of functions based on the at least one operator, and evaluating the expression using the selected at least one of the set of functions to manipulate the first set of data values to produce an expression result.

### TECHNOLOGICAL FIELD

Example embodiments of the present invention relate generally to methods for manipulating data and, more particularly, to a framework for representation and manipulation of data.

### BACKGROUND

Improvements in computing and communications technology have resulted in unprecedented access to data. Increased data storage capacities and transmission speeds allow users to share vast amounts of data with one another. Data from different sources may be extracted, analyzed, and processed to provide analytic, accounting, forecasting, and reporting functions to support decision-making processes. Such data is commonly expressed in table form, with rows and columns of the table corresponding to particular records and values.

One common method for storing and manipulating this data is through the use of spreadsheets. However, spreadsheets require formulae to be copied from cell to cell, with data references provided as cell address ranges rather than meaningful variable names. However, large and complicated spreadsheets tend to be fragile, difficult to manage, and difficult to integrate with other components of an information technology infrastructure. Alternatively, special-purpose applications may be written to perform predetermined iterative calculations across related tables, with output produced as a set of combined data formatted as a report.

Application development processes typically contemplate a separation between domain experts and application developers. The domain experts identify the correlations between data sets based on their system knowledge, and these correlations are used to determine requirements for the application developers. The application developers then write program code implementing the requirements defined by the domain experts. However, from the perspective of the domain experts, the resulting program output may function as a “black box”, with the inner workings obfuscated from the domain expert. As a result, verification of the output of the resulting program may prove difficult. From the perspective of the application developer, the requirements provided by the domain experts may be unclear or imprecise, resulting in implementation that does not directly correspond with the requests of the domain expert. Furthermore, implementation of operations and comparisons across data sets may require substantial redundant effort, since program code comparing two or more data sets may not be easily transferrable to other data sets. The need to rework existing code introduces the possibility of coding errors and bugs, which in turn results in processing errors and inaccurate data analysis. Through applied effort, ingenuity, and innovation, Applicant has solved many of these identified problems by developing a technical solution that is embodied by the present invention, which is described in detail below

### BRIEF SUMMARY

Methods, apparatuses and computer program products are therefore provided according to example embodiments of the present invention in order to provide a framework for data manipulation. Embodiments may include a method for evaluating expressions. In some embodiments, the method includes generating, using object generation circuitry, a first framework object from a set of input data. The first framework object includes a first set of data values and a set of structure data defining at least one dimension for formatting the first set of data values. The first framework object is associated with a set of functions for manipulating the first set of data values. The method also includes determining an expression to be performed on the first framework object, the expression comprising at least one operator, selecting at least one of the set of functions based on the at least one operator, and evaluating, using expression processing circuitry, the expression using the selected at least one of the set of functions to manipulate the first set of data values to produce an expression result.

Embodiments may further include an apparatus for providing an expression evaluation framework. The apparatus includes object generation circuitry and expression processing circuitry. The object generation circuitry is configured to generate a first framework object from a set of input data. The first framework object includes a first set of data values and a set of structure data defining at least one dimension for formatting the first set of data values. The first framework object is associated with a set of functions for manipulating the first set of data values. The object generation circuitry is further configured to determine an expression to be performed on the first framework object, the expression comprising at least one operator. The expression processing circuitry is configured to receive the set of input data, select at least one of the set of functions based on the at least one operator, and evaluate the expression using the selected at least one of the set of functions to manipulate the first set of data values to produce an expression result.

The expression may include an identification of a second framework object, and the selected at least one of the set of functions may further manipulates a second set of data values associated with the second framework object to produce the expression result. A structure of the expression result may be determined based on the structure data of the first framework object. The structure of the expression result may be the same as the at least one dimension of the first framework object. The operator may be at least one of a mathematical operator, a logical operator, or a set operator. The first framework object may be generated by a process comprising receiving the set of input data, determining a structure of the set of input data, and generating the first framework object by creating a data object comprising the set of input data, structure data corresponding to the determined structure, and at least one association with the set of functions.

The structure of the set of input data may be determined based on one or more dimension values explicitly specified during a definition of the first framework object. The structure of the set of input data may be inferred from the set of input data. The structure of the set of input data may be inferred from the set of input data by detecting a presence of a particular character within the set of input data. The set of functions may further include at least one function for modifying the set of structure data of the first framework object. In some embodiments, the first framework object includes data corresponding to an n-dimensional array, where the value of n is any integer greater than zero, and the structure data defines the dimensions of the n-dimensional array.

Embodiments may also include a computer program product including instructions for providing an expression evaluation framework. The computer program product comprises at least one computer-readable storage medium bearing computer program instructions embodied therein for use with a computer. The computer program instructions include program instructions configured to generate a first framework object from a set of input data. The first framework object includes a first set of data values and a set of structure data defining at least one dimension for formatting the first set of data values. The first framework object is associated with a set of functions for manipulating the first set of data values. The computer program instructions are further configured to determine an expression to be performed on the first framework object, the expression comprising at least one operator, to select at least one of the set of functions based on the at least one operator, and to evaluate the expression using the selected at least one of the set of functions to manipulate the first set of data values to produce an expression result.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is an illustration of an example data flow utilizing an expression evaluation framework in accordance with example embodiments of the present invention;

FIG. 3 is a block diagram depicting an example framework object in accordance with example embodiments of the present invention;

FIG. 4 is a flow diagram illustrating an example of a process for providing an expression result in accordance with example embodiments of the present invention;

FIG. 5 is a flow diagram illustrating an example of a process for generating a framework object in accordance with example embodiments of the present invention; and

FIG. 6 is a flow diagram illustrating an example of a process for evaluating an expression using an expression evaluation framework in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### INTRODUCTION AND DEFINITIONS

A method, apparatus and computer program product are provided in accordance with example embodiments of the present invention in order to provide a framework for manipulating data. In this regard, a method, apparatus and computer program product of an example embodiment may receive one or more input data tables. The input data tables may be converted into one or more framework objects. The framework objects may be used with a set of expressions to determine a set of expression results. The manner in which the expressions are applied to the framework objects may be determined based upon the structure and content of the associated framework objects. For example, the dimensions of one of the framework objects may determine a particular function used to evaluate the expression and to produce the set of expression results. In some embodiments, the ordering of the framework objects relative to the expression may determine the structure of the results.

For the purposes of this application, the term “framework object” is intended to refer to a data structure that includes a set of input data (e.g., a data table), and a definition of the structure of the input data (e.g., dimensions of a table storing the set of input data). Framework objects may be associated with a particular set of functions or expressions for evaluating data stored in the framework object. In some embodiments, these functions may take the form of overloaded operators, with different operations being performed based on the structure of the inputs to the operator. For example, a multiplication operator for a framework object of a particular set of dimensions may be overloaded such that the dimensions of framework object and the other input to the multiplication operation are used to select a particular multiplication function to produce the multiplication operation.

For the purposes of this application, the terms “expression” and “expressions” are intended to refer to a statement including at least one operator and at least one framework object. For example, an expression may define various mathematical operations performed using one or more sets of framework objects, including but not limited to addition, subtraction, multiplication, division, modulus, square, square root, summation, or the like. As described above, framework objects may be associated with a particular function or set of functions for each of these operations and, in some embodiments, the particular function associated with the framework object that is used for a particular mathematical operation may be defined based on the structure of the framework object, another input to the operator (e.g., another framework object, a variable of a different type, or constant value), or both. For example, the expression “object1×object2” may be evaluated using a different function if the structure of “object2” is a 1×3 data table (e.g., 1 row, 3 columns) than if the structure of “object2” is a 2×3 (e.g., 2 rows, 3 columns) data table.

### Example Apparatus

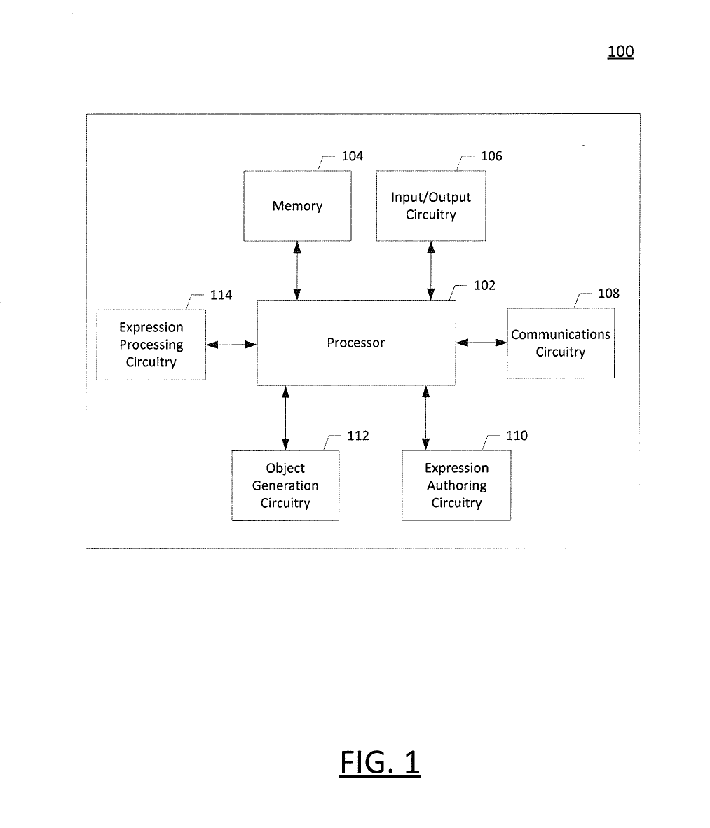

FIG. 1 illustrates a block diagram of an apparatus 100 in accordance with some example embodiments. The apparatus 100 may be any computing device capable of providing a framework for manipulating data as described herein. For example, the apparatus 100 may be implemented as a server (e.g., an application server implemented as a standalone or rack-mounted server), a desktop computer, a laptop computer, a personal digital assistant, a tablet computer, a netbook computer, a picture archiving and communication system (PACS) workstation, or the like. The apparatus 100 may be operable to receive data provided as one or more input data tables and generate framework objects from those input data tables. Expressions may be provided which are evaluated using the framework objects and functions associated therewith. The apparatus 100 may further provide an interface, such as an integrated development environment (IDE) for authoring and visualizing expressions, framework objects, and expression results. Accordingly, it will be appreciated that the apparatus 100 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

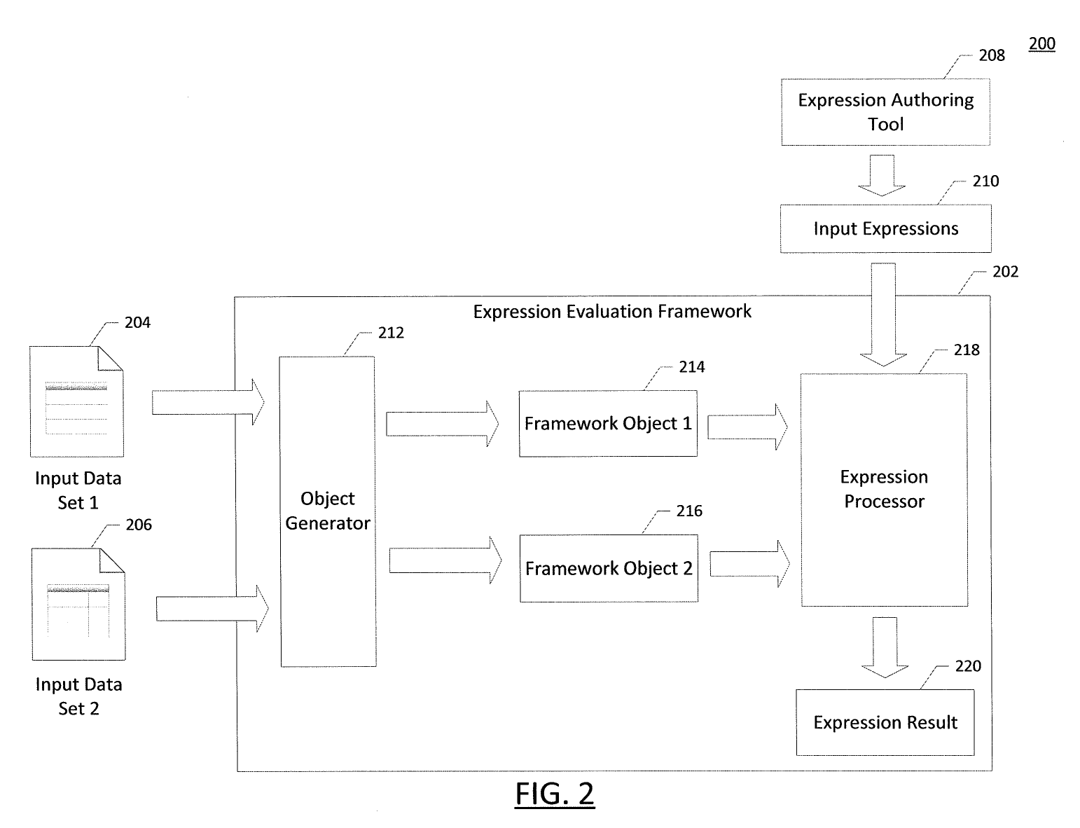

As illustrated in FIG. 1, an apparatus 100 may include a processor 102, a memory 104, input/output circuitry 106, communications circuitry 108, expression authoring circuitry 110, object generation circuitry 112, and expression processing circuitry 114. The apparatus 100 may be configured to execute the operations described below with respect to FIGS. 2-6. Although these components 102-114 are described with respect to functional limitations, it should be understood that the particular implementations necessarily include the use of particular hardware. It should also be understood that certain of these components 102-114 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 100 may provide or supplement the functionality of particular circuitry. For example, the processor 102 may provide processing functionality, the memory 104 may provide storage functionality, the communications circuitry 108 may provide network interface functionality, and the like.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory may be an electronic storage device (e.g., a computer readable storage medium). The memory 104 may be configured to store information, data, content, applications, instructions, or the like, for enabling the apparatus to carry out various functions in accordance with example embodiments of the present invention.

The processor 102 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 102 may be configured to execute instructions stored in the memory 104 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 100 may include input/output circuitry 106 that may, in turn, be in communication with processor 102 to provide output to the user and, in some embodiments, to receive an indication of a user input. The input/output circuitry 106 may comprise a user interface and may include a display and may comprise a web user interface, a mobile application, a client device, a kiosk, or the like. In some embodiments, the input/output circuitry 106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

The communications circuitry 108 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 108 may include, for example, a network interface for enabling communications with a wired or wireless communication network. For example, the communications circuitry 108 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The expression authoring circuitry 110 includes hardware configured to provide a user with the ability to author one or more expressions for evaluation. The expression authoring circuitry 110 may utilize processing circuitry, such as the processor 102, to perform these actions. The expression authoring circuitry 110 may receive information used to author the expressions via various interface devices, including interface devices provided by the input/output circuitry 106. In some embodiments, the expression authoring circuitry 110 may utilize an output device provided by the input/output circuitry 106 (e.g., a display device) to provide visual feedback to the user during the expression authoring process. However, it should also be appreciated that, in some embodiments, the expression authoring circuitry 110 may include a separate processor, specially configured field programmable gate array (FPGA), or application specific interface circuit (ASIC) to provide the functions of authoring a set of expressions which may then be evaluated using other components of the apparatus 100. The expression authoring circuitry 110 is therefore implemented using hardware components of the apparatus configured by either hardware or software for implementing these planned functions.

The object generation circuitry 112 includes hardware configured to generate an object having a particular defined format based on input data. The generated object may then be used by other components of the apparatus to assist with evaluation of expressions using the data which was used to generate the object. In this manner, the object generation circuitry 112 may include hardware and software for receiving a set of data, such as via a storage device or communications circuitry (e.g., a network interface). The object generation circuitry 112 may further utilize processing circuitry, such as the processor 102, to generate an object based upon the received data. The generated object may further be associated with a set of functions used to evaluate expressions using the object. It should also be appreciated that, in some embodiments, the object generation circuitry 110 may include a separate processor, specially configured field programmable gate array (FPGA), or application specific interface circuit (ASIC) to provide the functions of generating a set of objects for use in evaluation of expressions by other components of the apparatus 100. The object generation circuitry 110 is therefore implemented using hardware components of the apparatus configured by either hardware or software for implementing these planned functions.

The expression processing circuitry 114 includes hardware configured to process expressions using one or more objects generated by the object generation circuitry 112. The expression processing circuitry may utilize processing circuitry, such as the processor 102, to perform these actions. The expression processing circuitry 114 may obtain objects and associated functions by accessing a storage device, such as the memory 104. The expression processing circuitry 114 may thus evaluate expressions using the objects through the use of processing circuitry, and provide the results of the evaluated expressions to a storage device, such as the memory 104, or as output to another device or set of circuitry, such as using a network interface provided by the communications circuitry 108 or an output device (e.g., a display) provided by the input/output circuitry 106. In some embodiments, the expression authoring circuitry 110 may utilize a display device to provide visual feedback to the user during the expression authoring process. It should also be appreciated that, in some embodiments, the object generation circuitry 110 may include a separate processor, specially configured field programmable gate array (FPGA), or application specific interface circuit (ASIC) to provide the functions of generating a set of objects for use in evaluation of expressions by other components of the apparatus 100. The expression processing circuitry 110 is therefore implemented using hardware components of the apparatus configured by either hardware or software for implementing these planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of apparatus 100. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Expression Evaluation Framework Data Flow

FIG. 2 is an illustration of an example data flow 200 utilizing an expression evaluation framework in accordance with example embodiments of the present invention. The data flow 200 illustrates how a first input data set 204 and a second input data set 206 may be processed according to a set of input expressions 210 via an expression evaluation framework 202 to determine an expression result 220. The input data sets 204, 206 may be any set of data presented in an array of n dimensions, where n is a natural number greater than zero. For example, the input data sets may be two dimensional tables with rows and columns, or the input data sets may include additional dimensions. In some embodiments, the input data sets may be presented in a spreadsheet format (e.g., in a file format compatible with a spreadsheet program), as comma separated value (CSV) files, as strings, or in any other format suitable for providing a set of input data according to an explicitly or implicitly defined structure. In the present context, an explicitly defined structure should be understood to refer to a data structure that includes explicit definitions of the dimensions of the input data (e.g., defining a particular number of rows, columns, or other dimensions), while an implicitly defined structure should be understood to refer to a data structure from which dimensions can be inferred, even if not explicitly defined (e.g., a set of input data with particular characters or terms indicating separations between data values, such as a set of comma separated values with a repeating term at regular intervals from which rows may be inferred).

An expression authoring tool 208 may be employed to provide one or more input expressions 210. The expression authoring tool 208 may be implemented via expression authoring circuitry 110, as described above with respect to FIG. 1. The expression authoring tool 208 may be any application suitable for defining a set of expressions to be evaluated. For example, the expression authoring tool may be an IDE capable of generating an application that employs the expression evaluation framework. The expression authoring tool 208 may enable a user to define a set of framework objects and create expressions for manipulating data contained within the set of framework objects. These expressions may define relationships among data stored within the framework objects which, when evaluated, provide a set of expression results.

The expression authoring tool 208 may further leverage the expression evaluation framework 202 to improve the ability of users to author, test, and debug a set of input expressions authored for use with the expression evaluation framework 202. For example, where the expression authoring tool 208 includes an IDE, the expression authoring tool 208 may provide the ability to view the structure and contents of data stored in particular framework objects. The expression authoring tool 208 may further offer benefits such as a symbolic debugger that enables a user to step through evaluation of expressions, including visibility into function libraries associated with particular framework objects. The expression authoring tool 208 may also provide for integrated program building and compilation functions, source control and unit testing tools, and the like. It should be appreciated that the expression authoring tool 208 may also include a set of libraries, headers, and/or other components used in the development, compiling, and execution of applications incorporating the input expressions 210.

The expression evaluation framework 202 may include various hardware and software components for generating expression results from a set of input expressions 210 and input data sets 204, 206. To this end, the expression evaluation framework 202 may work in concert with elements of a computing system or systems such as described above with respect to FIG. 1. In some embodiments, an object generator 212 is employed to generate a first framework object 214 and a second framework object 216 from the first input data set 204 and the second input data set 206, respectively. For example, the object generator 212 may take the form of a constructor function or object definition function that receives a set of input data. In some embodiments, the object generator 212 may be implemented by object generation circuitry 112 as described above with respect to FIG. 1. The object generator 212 may determine the dimensions of the input data and associate the input data with a set of functions used to assist with evaluation of expressions using the input data. For example, the object generator may generate objects belonging to a particular class, with the behavior of particular mathematical operators defined within the class.

The class may further include functions for managing and manipulating the data and the associated dimensions. For example, these functions may include, but are not necessarily limited to, alteration of the dimensions of the data, transposition of elements of the data, shifting of elements of the data, determining a count of values in the data, the average, maximum, minimum, median, or mode of the data, or performing matrix slicing operations on the data. These functions may modify and/or be aware of the dimensions associated with the data object as well as the content of the data itself. Embodiments may further leverage known data typing and behaviors of an underlying framework to evaluate expressions. For example, a particular framework (e.g., Groovy or Java®) may include default behaviors for evaluating expressions using data of certain types (e.g., floats, integers, strings, doubles, and the like), such that the expression evaluation framework 202 leverages these default behaviors when evaluating expressions using one or more framework objects. The resulting data structure incorporating the input data, the dimensions, and the associated functions may be represented as a framework object.

In the present example, each of the input data sets 204, 206 has been used to generate a corresponding framework object 214, 216. These framework objects 214, 216 include associations with particular functions according to the data stored in the framework objects. For example, the first framework object 214 may have a particular set of dimensions and thus be associated with a first set of functions which define mathematical operations for manipulating the data of the first framework object, and the second framework object 216 may have a different set of dimensions and thus be associated with a different set of functions defining mathematical operations for manipulating the data of the second framework object.

The particular functions that are associated with particular dimensions and structures of the framework object may be defined within the expression evaluation framework 202. For example, the expression evaluation framework 202 may include particular libraries and/or function definitions for association with framework objects of particular dimensions which are linked to the framework objects at the time the framework objects are generated. In some embodiments, these libraries may define different operator overloads depending upon the dimensions of the framework object and the structure of the other terms applied to the operator in the expression.

The framework objects 214, 216, and the input expressions 210 may be provided to an expression processor 218 to evaluate the expressions using the data of the framework objects 214, 216. For example, the set of input expressions may include a set of mathematical operations to be performed on the data sets of each framework object. In some embodiments, the expression processor 218 may be implemented as expression processing circuitry 114 as described above with respect to FIG. 1. In evaluating expressions, the expression processor 218 may first identify the function associated with the particular operator for a first framework object associated with the expression (e.g., the framework object that represents the object to the left side of the operator). The expression processor may then execute the function to evaluate the results of the mathematical relationship between the objects. The result of evaluation of the expression may be presented as an expression result 220. The expression result 220 may be another framework object, or one of the previously generated framework objects may be edited to be used as the expression result 220.

As described above, the expression evaluation framework may utilize a single framework object type which comprises a dimension specification and a list of data values. When two objects are involved in an expression operation together, the expression evaluation framework 202 may manage the iteration through both of the objects' lists of data values following the dimension specifications of the respective objects. For example, an operation combining a 1×3 table and a 2×3 table may create a result table with the shape of the 1×3 operand. This operation may then follow an iteration pattern illustrated by the following sequence, given these table-cell addresses in X-Y coordinate notation:

TABLE 1

| | | | | | |
|---|---|---|---|---|---|
| 1×3 = | 1,1 | + | 2×3 = | 1,1 | 2,1 |
| | 1,2 | | | 1,2 | 2,2 |
| | 1,3 | | | 1,3 | 2,3 |

A result may be accumulated during the following iteration steps. Before the iteration begins, the list of values in the left operand may be copied to a temporary “result” list. At each step in the iteration the result of the operation may be stored back into the “result” list. For the sample sub-expression “a+b”, the expression executed may be “result=a; result=result+b”. The net effect of the use of “result” is that in the sequence described below, at step 2, the value at 1,1 contains the result of step 1:

TABLE 2

| | |
|---|---|
| 1. | 1,1 = 1,1 + 1,1 |
| 2. | 1,1 = 1,1 + 2,1 |
| 3. | 1,2 = 1,2 + 1,2 |
| 4. | 1,2 = 1,2 + 2,2 |
| 5. | 1,3 = 1,3 + 1,3 |
| 6. | 1,3 = 1,3 + 2,3 |

Upon each step, the framework may execute the overloaded function for the corresponding operator (e.g., “plus”) associated with the object. An example overloaded operator implementing the above calculation is:

TABLE 3

```
def plus(object b) {
      return iterate (b, ‘plus’, {v0,v1->
            v0 + v1
      })
}
```

In the object “plus” implementation described above in Table 3, another object is “added” to it. The plus function may call the iterate method to visit each element of both objects (e.g., both the class object and the object “b” provided as an argument to the operator) as described above, and during each visit the function may call the “closure” expression passed as the last parameter to the iterate method. In the present context, a “closure” is an anonymous method that can be manipulated like data and called to execute in context. This closure, when called, performs the “plus” operation on the individual elements (v0 and v1) passed to the closure. These elements may be any type of object that implements the “plus” behavior, for instance, integers, doubles, strings or a variety of other data types. In some embodiments, the expression evaluation framework may leverage standard expression processing rules of another framework (e.g., Groovy or Java®) to perform the processing of the closure element. For instance, type promotion of integer values to equivalent double values may be performed before adding the values together, or if v0 was a string object and v1 was a double, the result might be the string version of the double concatenated to the string, depending upon the expression evaluation logic associated with the other framework. In this manner, some embodiments of the expression evaluation framework may be said to extend, build upon, leverage, or otherwise utilize other base frameworks, such as Groovy and/or Java®. Furthermore, although the example above relates to implementation of a “plus” operator, it should be readily apparent how other mathematical, logical, and set operators could also be implemented to effect manipulations of objects with respect to one another via the principles of operator overloading. The operators employed may be either binary (e.g., taking two input objects) or unary (e.g., taking a single input object). In the case of binary operators, the dimensions of the output result may be defined by the dimensions of a particular one of the objects provided as an input (e.g., the object to the left of the operator).

As yet further examples of the use of the expression evaluation framework to provide a simplified process for manipulation of data, the following example concerns a set of data relevant to the healthcare field. As an initial matter, a set of data may be gathered. This input data may be represented as a set of input data values, such as the data sets 204, 206. These data sets may be implemented in a variety of formats, including, as depicted in the present example, a set of multi-line strings defined between matching triple quotes (″″″). A whole table may be expressed as a string then parsed into the appropriately shaped table. The present example relates to the use of input data to calculate a need for beds in a hospital neonatal unit based on past data and expected future data. Each of the 11 columns of the following sets of input data may correspond to a particular district, with different rows corresponding to particular years (e.g., 2012, 2013, and 2014 data).

TABLE 4
// Number of Patient Days for 12 Month Period
def PD2 = new Object( ) << “““

| | | | | | | | | | | |
|---|---|---|---|---|---|---|---|---|---|---|
| 10091 | 7983 | 13384 | 21367 | 25732 | 27649 | 40338 | 18768 | 21075 | 28515 | 56832 |
| 10802 | 7950 | 13758 | 23113 | 22769 | 24072 | 41113 | 19361 | 23485 | 26272 | 55266 |
| 10729 | 7567 | 13583 | 24499 | 22716 | 25316 | 42616 | 18372 | 23741 | 32926 | 54381 |
| ””” | | | | | | | | | | |

// Resident Live Births for 2011
def AB = new Object( ) << “““

| | | | | | | | | | | |
|---|---|---|---|---|---|---|---|---|---|---|
| 9311 | 8674 | 16701 | 24299 | 13717 | 29618 | 28898 | 15262 | 20324 | 21394 | 33048 |
| 8961 | 8061 | 15858 | 22848 | 12988 | 28325 | 28786 | 14472 | 19786 | 21075 | 32069 |
| 9054 | 8100 | 15582 | 23031 | 13182 | 28389 | 28947 | 14523 | 19783 | 21169 | 31188 |
| ””” | | | | | | | | | | |

// Projected Number of Live Births for the Planning Horizon
def PB = new Object( ) << “““

| | | | | | | | | | | |
|---|---|---|---|---|---|---|---|---|---|---|
| 9416 | 8807 | 17630 | 24986 | 13893 | 31403 | 31022 | 16712 | 21546 | 21555 | 33379 |
| 8908 | 8419 | 17299 | 24542 | 13635 | 31104 | 30711 | 16022 | 21427 | 20969 | 33065 |
| 9122 | 8283 | 16547 | 23894 | 13220 | 30039 | 30502 | 15606 | 20709 | 21111 | 32427 |
| ””” | | | | | | | | | | |

// Number of Licensed Level II Beds
def LB2 = new Object( ) << “““

| | | | | | | | | | | |
|---|---|---|---|---|---|---|---|---|---|---|
| 38 | 23 | 40 | 107 | 50 | 95 | 130 | 53 | 93 | 132 | 191 |
| 38 | 23 | 40 | 107 | 50 | 95 | 135 | 53 | 93 | 132 | 202 |
| 38 | 35 | 52 | 107 | 50 | 95 | 135 | 60 | 99 | 132 | 202 |
| ””” | | | | | | | | | | |

// Number of Approved Level II Beds
def AB2 = new Object( ) << “““

| | | | | | | | | | | |
|---|---|---|---|---|---|---|---|---|---|---|
| 4 | 8 | 0 | −6 | 5 | 0 | 11 | 0 | 6 | 0 | 11 |
| 4 | 18 | 18 | −6 | 5 | 0 | 10 | 17 | 6 | 0 | 10 |
| 0 | 0 | 18 | −7 | 17 | 0 | 27 | 17 | 6 | 0 | 22 |
| ””” | | | | | | | | | | |

In the example input data depicted above with respect to Table 4, the objects PD2, AB, PB, LB2, and AB2 are being created from input data sets defined in the above strings. As described above, each of these objects may be implemented as a framework object of a particular class and having particular associated functions allowing for easy manipulation of the data. In the present example related to the hospital neonatal bed need calculation, a desired bed occupancy of 80% may be used as a standard, with an understanding that a given year has 365 days. The state for which the bed need is being calculated may be understood to have 11 districts, hence the 11 columns of the input data sets. As such, the formula used to determine the estimated bed need may be defined as follows:

TABLE 5
// NN2 is the net need for Level II beds in a year
def NN2 = (( PD2 * PB / AB) / (365 * 0.80 )) − LB2 − AB2

As described above, each of the objects may be associated with overloaded operators such that evaluation of the above expression results in the appropriate operations being performed to manipulate the data of each object as desired by the author of the application. In order to determine the output of the newly defined object “NN2”, an assert method may be employed. In the present context, an “assert” or assertion is a test of equivalence between something known and something calculated. If they are not equivalent, an error is thrown. In this case, the content of the object NN2 is compared to a framework object constructor with parameters creating an object instance of a particular shape and content. Specifically, in the context of the calculation performed above, the results are the net bed-need projections for three years across eleven districts as depicted below in Table 6:

TABLE 6

```
assert NN2.round( ) == new Object([11, 3, 1],
        [−7, −3, 8, −26, 34, 5, 7, 17, −22, −34, −5,
        −5, −13, −7, −16, 27, −4, 5, 3, −12, −42, −17,
        −1, −9, −21, −13, 11, −3, −8, −9, −20, −20, −30]
        }
```

A second example is given of the same methodology slightly modified to support modeling projections over a variety of bed percentage occupancies, and includes a formatted, printed result. The following example shows expression modification using the commutative property of multiplication to change the order of the sub-expression “365*0.80” in order to introduce a variable with different percentage rates; combining strings and numbers together to produce formatted results; and expansion of the shapes of objects in order to receive results within the expression due to the enlargement of the modeled data. For the sake of brevity, the same input data sets for the objects PD2, AB, PB, LB2, and AB2 are assumed. Unlike the static value of 80% utilized in the example above, the following example defines a new object with varying standards between 76% and 88%, defined as the new object, PCT:

TABLE 7

```
def PCT = new Object( ) << “““
      0.88 0.84 0.80 0.76
      ”””
```

In order to ensure that the values line up properly with the 11×3 matrix of district-by-year data, the dimensions of the PCT object may be altered using the PCT.dim method. For example, the following expression may convert the PCT object to a 1×1×4 object instead of a 1×4 object:

TABLE 8
PCT.dim([1,1,4])

To calculate the resulting object, the formula described above in Table 5 may be modified slightly to capture the result of the sub-expression reflecting the PCT data set, supporting the intend to model with different percentages for the occupancy rate, such as by modifying the expression to read “PCT*365”. Additionally, the PD2 object may be expanded in the third dimension “[11,3,4]” to accommodate the varied rate calculations:

TABLE 9

def NN2 = (( PD2.expand([11,3,4]) * PB / AB) / (PCT * 365 )) −
LB2 − AB2

The result of the calculation for the result, NN2, may be formatted and displayed follows:

TABLE 10
NN2 =

| | | District | | | | | | | | | | |
|---|---|---|---|---|---|---|---|---|---|---|---|---|
| Pct | Year | 1 | 2 | 3 | 4 | 5 | 6 | 7 | 8 | 9 | 10 | 11 |
| 0.88 | 2014 . . . | −10 | −5 | 3 | −32 | 26 | −3 | −6 | 10 | −29 | −42 | −23 |
| 0.88 | 2015 . . . | −8 | −15 | −11 | −23 | 19 | −12 | −8 | −3 | −19 | −50 | −34 |
| 0.88 | 2016 . . . | −4 | −10 | −25 | −20 | 3 | −11 | −22 | −15 | −27 | −29 | −47 |
| 0.84 | 2014 . . . | −8 | −4 | 6 | −29 | 30 | 0 | 0 | 14 | −26 | −38 | −14 |
| 0.84 | 2015 . . . | −6 | −13 | −9 | −20 | 22 | −8 | −1 | 0 | −16 | −46 | −26 |
| 0.84 | 2016 . . . | −2 | −9 | −22 | −17 | 7 | −7 | −15 | −12 | −23 | −24 | −39 |
| 0.80 | 2014 . . . | −7 | −3 | 8 | −25 | 34 | 5 | 7 | 17 | −22 | −33 | −5 |
| 0.80 | 2015 . . . | −5 | −12 | −6 | −15 | 26 | −4 | 5 | 3 | −11 | −42 | −16 |
| 0.80 | 2016 . . . | 0 | −8 | −20 | −12 | 11 | −3 | −8 | −9 | −19 | −19 | −30 |
| 0.76 | 2014 . . . | −5 | −1 | 10 | −21 | 38 | 10 | 15 | 21 | −18 | −28 | 4 |
| 0.76 | 2015 . . . | −3 | −11 | −3 | −11 | 31 | 0 | 13 | 7 | −7 | −37 | −6 |
| 0.76 | 2016 . . . | 0 | −7 | −18 | −8 | 15 | 1 | 0 | −5 | −15 | −13 | −20 |

### Example Framework Object

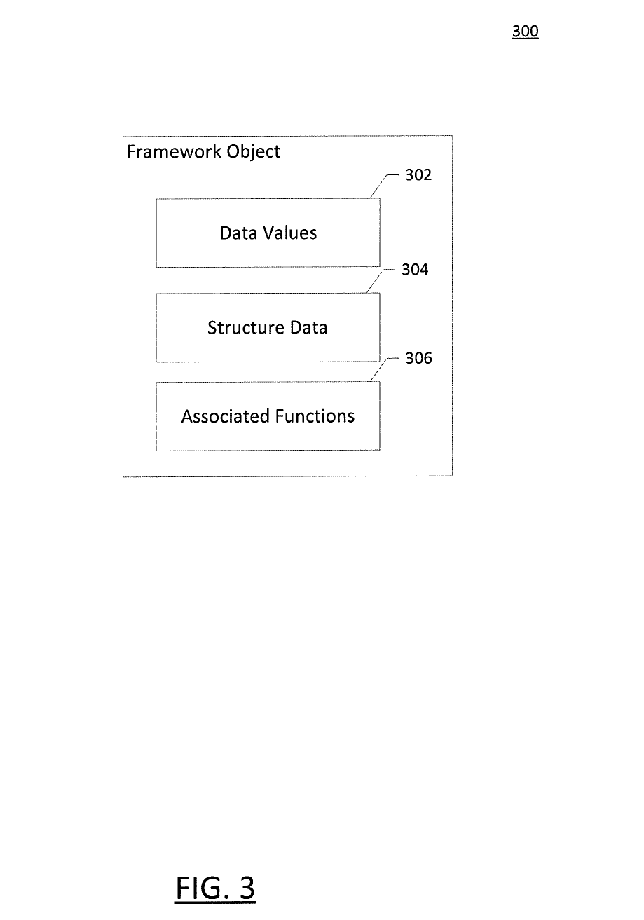

FIG. 3 is a block diagram depicting an example framework object 300 in accordance with some example embodiments. As described above with respect to FIG. 2, one or more framework objects may be generated by providing a set of input data to an object generator (e.g., a constructor function). The object generator may generate a new framework object from the input data. For example, an object may be defined of a particular class associated with the object generator. The generated framework object may include a representation of values of the input data 302. These data values 302 may be stored as a list of values. The framework object 300 may also include structure data 304. The structure data 304 may define a structure for the data values 302. For example, the structure data 304 may include data indicating the dimensions of an array for storing the data values 302. The structure data 304 may be explicitly defined at the time the framework object 300 is created (e.g., as an argument to a function defining an object of the particular class), or the structure data 304 may be implicitly defined based on the set of input data (e.g., by parsing the input data for particular characters that indicate a particular structure, such as comma separated values, carriage returns, line feeds, or the like). The framework object 300 may also include a set of associated functions 306. These associated functions may be stored with the framework object 300 itself, or implemented as a set of library functions linked to by references within the framework object 300. For example, the framework object 300 may include a set of functions associated with the particular class of the framework object 300 which include various functions for accessing and manipulating the data values 302 stored within the framework object 300. The set of associated functions 306 may further include a set of associated overloaded operators associated with the framework object, as described above with respect to FIG. 2.

### Example Processes for Implementing an Expression Evaluation Framework

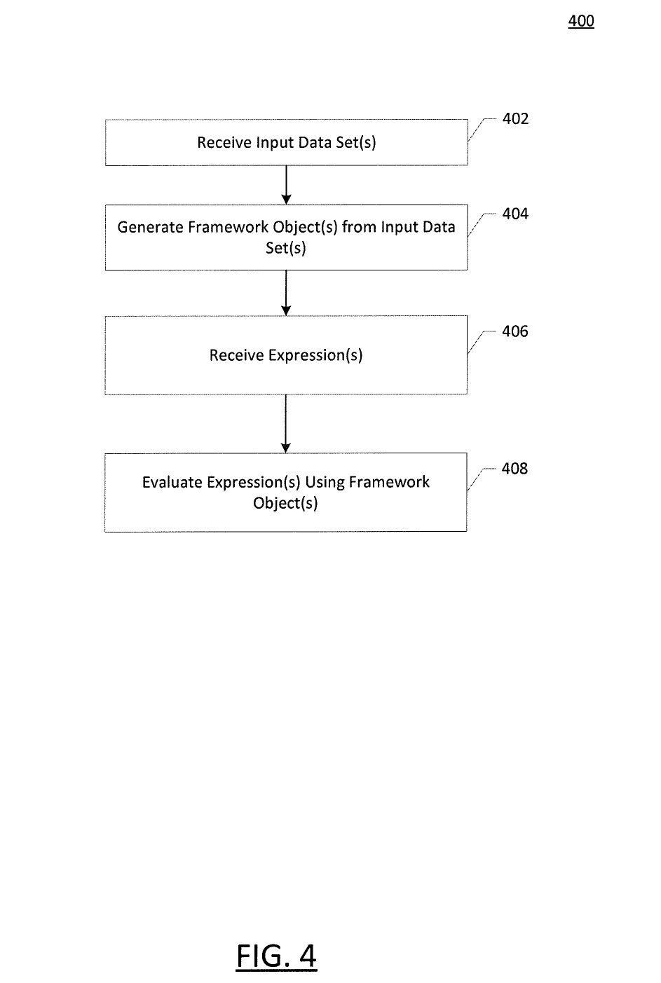

FIG. 4 is a flow diagram illustrating an example of a process 400 for providing an expression result in accordance with example embodiments of the present invention. The process 400 may be operable to provide a straightforward implementation of a framework that allows for manipulation of data sets in a straightforward manner while also supporting management and manipulation of aggregate, n-dimensional matrices of homogeneous data. Embodiments of the process 400 may be performed by an apparatus, such as the apparatus 100 described with respect to FIG. 1, and as part of an expression evaluation framework 202 such as described with respect to FIG. 2.

At action 402, one or more sets of input data are received. As described above with respect to FIGS. 2 and 3, the input data sets may be received in a variety of formats. For example, the input data sets may be received as sets of comma separated values, as a string with particular characters delimiting data values, as a spreadsheet, or via any other format for providing a set of data. The input set of data may have an explicitly defined structure, or the structure of the data may be inferred from the input values. It should be appreciated that embodiments may include various methods of parsing input data sets and structuring input data sets to present the input data sets in a format that is suitable for using to generate a framework data object. In some embodiments, the set of input data may be dynamically defined such as by calling an application programming interface (API) function for a particular sensor, datastore, or other source of data located external to the program or source code file defining the framework object.

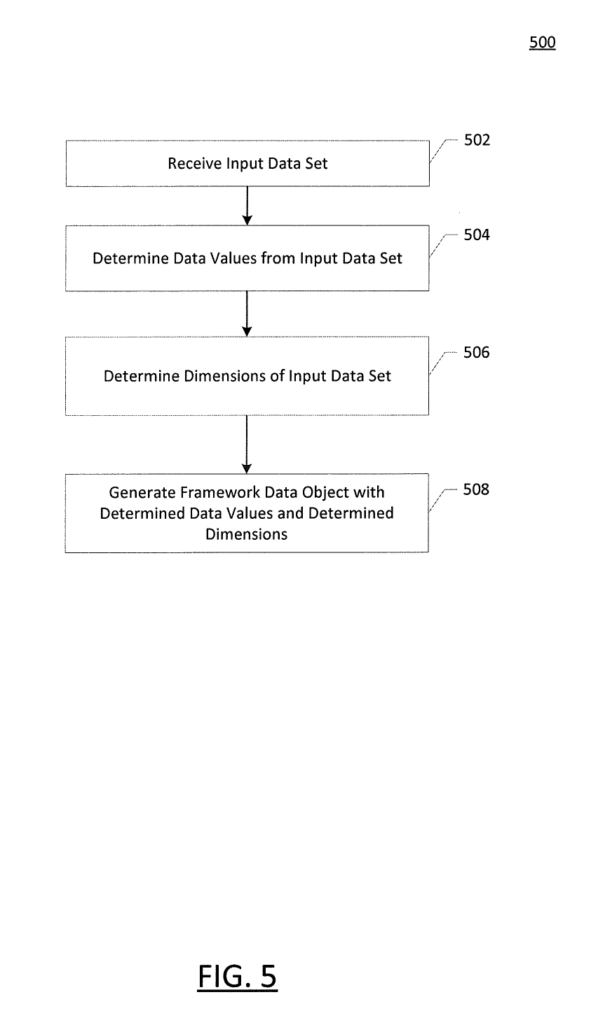

At action 404, one or more framework objects are created from the one or more sets of input data. As described above with respect to FIGS. 2 and 3, generation of the framework objects may include generating an object of a particular class associated with the framework. For example, generation of the framework data object may include creation of an object as described with respect to FIG. 3, with a set of data values corresponding to the set of input data. Generation of the framework data object may also include associating the framework data object with functions and overloaded operators which may be used to access, edit, and modify the data stored in the framework object. An example process for generating a data object is described further below with respect to FIG. 5.

At action 406, a set of input expressions are received. For example, these input expressions may be defined within a program, as part of an application, as lines within a set of source code interpreted by an interpreter application, or the like. The expressions may define operations to be performed using one or more of the framework objects. For example, binary expressions may define operations that apply the data of a second data object to a first data object (e.g., addition, subtraction, multiplication, division, comparison, or the like). Unary expressions may define an operation performed on a first data object, such as squaring the data object.

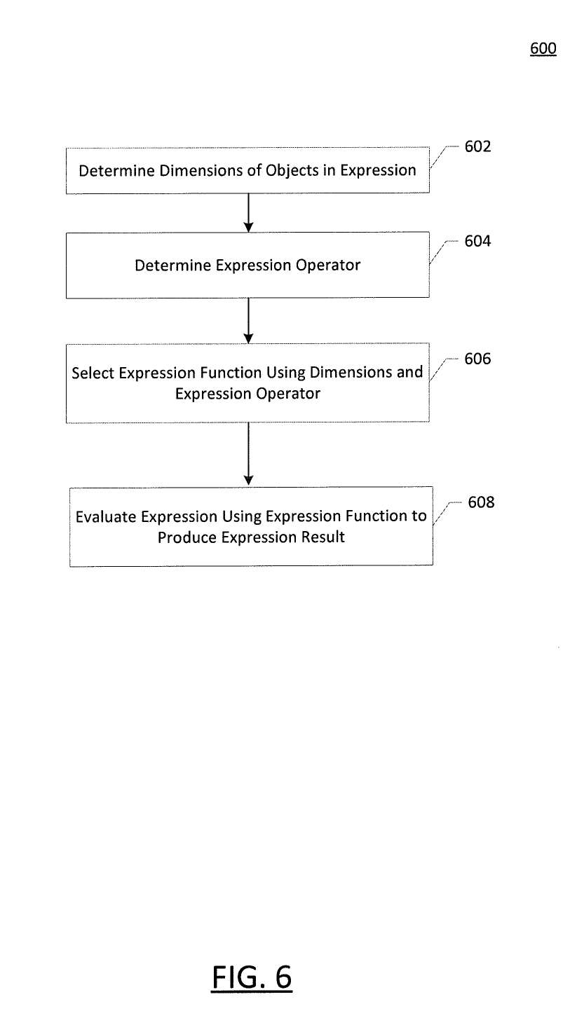

At action 408, the expressions are applied to the framework object or objects. Application of the expressions may include determining a structure of an expression result and an appropriate overloaded operator for implementing the expression on the framework objects. An example method for evaluating the expressions as applied to the framework object or objects is described further with respect to FIG. 6. The results of the expression evaluation may be provided as a set of expression results. These expression results may be provided as another, separate framework object, as a formatted report, or by modifying one of the original framework objects used to evaluate the expression.

FIG. 5 is a flow diagram illustrating an example of a process 500 for generating a framework object in accordance with example embodiments of the present invention. As described above with respect to FIGS. 2-4, a set of input data values may be used to generate a framework object. The generated framework object may include a set of structure data describing the structure of the data values and a set of associated functions for accessing and manipulating the data of the framework object. Embodiments of the process 500 may be performed by an apparatus, such as the apparatus 100 described with respect to FIG. 1, and as part of an expression evaluation framework 202 such as described with respect to FIG. 2. The process 500 may be performed as part of the expression evaluation process 400 described above with respect to FIG. 4.

At action 502, an input data set is received. As described above, the input data set may be received from a variety of sources. In some embodiments, the input data set is formatted, while in some embodiments the input data set may be provided as part of a data stream that is formatted at the time of generation of the framework object. The input data set may include an explicitly defined structure (e.g., dimensions of an array indicated by data values supplied alongside the data values), or an implicitly defined structure (e.g., dimensions that can be inferred based on the content, structure, and/or ordering of the data values).

At action 504, the data values of the input data set are determined. These data values may be used to define the data values of the framework object (e.g., the data values 302 described above with respect to FIG. 3). These data values may be stored as a list, such as in a one-dimensional array, or the data values may be stored with additional structure (e.g., an n-dimensional array, a dynamic array, or the like).

At action 506, a structure of the input data set is determined. As described above with respect to FIGS. 2-4, the structure of the input data set may be inferred from the input data (e.g., by detection of particular characters, strings, values, ordering, or the like), or explicitly defined by the input data (e.g., passing data indicating the structure of the data values as an argument at the time the framework object is generated). The structure may be stored as a set of structure data for the framework object (e.g., the structure data 304 described above with respect to FIG. 3).

At action 508, a framework data object is generated. The framework data object may have data values as determined at action 504, and structure data as determined at action 506. Generation of the framework data object may further include association of the framework data object with a set of functions and/or overloaded operators of a particular class. These functions and/or overloaded operators may allow for the use of the framework data object in evaluation of various expressions such that the data stored within the framework object may be accessed and manipulated in a straightforward, robust, and user-friendly manner. An example process for evaluating such expressions is described further below with respect to FIG. 6.

FIG. 6 is a flow diagram illustrating an example of a process 600 for evaluating an expression using an expression evaluation framework in accordance with example embodiments of the present invention. As described above with respect to FIGS. 2-5, some embodiments allow for the use of expressions to manipulate data stored in framework data objects. For example, these expressions allow mathematical, logical, and set operations to be performed using arrays of data in a straightforward manner without requiring users to manually implement code to perform iteration across individual elements of the framework objects. Embodiments of the process 600 may be performed by an apparatus, such as the apparatus 100 described with respect to FIG. 1, and as part of an expression evaluation framework 202 such as described with respect to FIG. 2. The process 600 may be performed as part of the expression evaluation process 400 described above with respect to FIG. 4.

At action 602, the dimensions of the objects involved in an expression are determined. These dimensions may correspond to structure data stored with each object. At action 604, the operator of the expression is determined. For example, as described above, the expression evaluation framework may support a variety of mathematical, logical, and set operators. At action 606, the dimensions determined at action 602 and the operator determined at action 604 are used to select a particular function (e.g., a function associated with an overloaded operator of a particular type) to perform using the framework objects to produce a result. In some embodiments, the particular function is operable to structure output based on the dimensions of the dimensions of the framework object positioned to the left of the operator. For example, if the left side object controls the output result, an expression is implemented as “object1+object2” and object1 is a 2×3 array and object2 is a 1×2 array, then the result of the expression would be provided as a 2×3 array, while if the expression was “object2+object1”, then the result would be a 1×2 array. Similarly, if the left side object is a three dimensional array and the right side object is a two dimensional array, then the output of the function would be structured to provide a three dimensional array with the same dimensions as the left side input.

At action 608, the expression is evaluated based on the function selected at action 606. For example, the selected function may iteratively perform certain operations (e.g., addition in the case of a “plus” operator) across the values of each data object to produce an expression result. The expression result may be provided in the form of another framework object, as an output report, as a modification to one of the input framework objects, or according to any other suitable format.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for providing an expression evaluation framework comprising:
generating, using object generation circuitry, a first framework object from a set of input data, the first framework object comprising a first set of data values and a set of structure data defining at least one dimension for formatting the first set of data values, wherein the first framework object is associated with a set of functions for manipulating the first set of data values;
determining an expression to be performed on the first framework object, the expression comprising at least one operator;
selecting at least one of the set of functions based on the at least one operator; and
evaluating, using expression processing circuitry, the expression using the selected at least one of the set of functions to manipulate the first set of data values to produce an expression result.

2. The method of claim 1, wherein the expression further comprises an identification of a second framework object, and wherein the selected at least one of the set of functions further manipulates a second set of data values associated with the second framework object to produce the expression result.

3. The method of claim 2, wherein a structure of the expression result is determined based on the structure data of the first framework object.

4. The method of claim 3, wherein the structure of the expression result is the same as the at least one dimension of the first framework object.

5. The method of claim 1, wherein the operator is at least one of a mathematical operator, a logical operator, or a set operator.

6. The method of claim 1, wherein the first framework object is generated by a process comprising:
receiving the set of input data;
determining a structure of the set of input data; and
generating the first framework object by creating a data object comprising the set of input data, structure data corresponding to the determined structure, and at least one association with the set of functions.

7. The method of claim 6, wherein the structure of the set of input data is determined based on one or more dimension values explicitly specified during a definition of the first framework object.

8. The method of claim 6, wherein the structure of the set of input data is inferred from the set of input data.

9. The method of claim 8, wherein the structure of the set of input data is inferred from the set of input data by detecting a presence of a particular character within the set of input data.

10. The method of claim 1, wherein the set of functions further comprise at least one function for modifying the set of structure data of the first framework object.

11. The method of claim 1, wherein the first framework object includes data corresponding to an n-dimensional array, where the value of n is any integer greater than zero, and wherein the structure data defines the dimensions of the n-dimensional array.

12. An apparatus for providing an expression evaluation framework, the apparatus comprising:
object generation circuitry configured to:
generate a first framework object from a set of input data, the first framework object comprising a first set of data values and a set of structure data defining at least one dimension for formatting the first set of data values, wherein the first framework object is associated with a set of functions for manipulating the first set of data values; and
determine an expression to be performed on the first framework object, the expression comprising at least one operator; and
expression processing circuitry configured to:
receive the set of input data;
select at least one of the set of functions based on the at least one operator; and
evaluate the expression using the selected at least one of the set of functions to manipulate the first set of data values to produce an expression result.

13. The apparatus of claim 12, wherein the expression further comprises an identification of a second framework object, and wherein the selected at least one of the set of functions further manipulates a second set of data values associated with the second framework object to produce the expression result.

14. The apparatus of claim 13, wherein a structure of the expression result is determined based on the structure data of the first framework object.

15. The apparatus of claim 14, wherein the structure of the expression result is the same as the at least one dimension of the first framework object.

16. The apparatus of claim 12, wherein the operator is at least one of a mathematical operator, a logical operator, or a set operator.

17. The apparatus of claim 12, wherein the object generation circuitry is configured to generate the first framework object by:
receiving the set of input data;
determining a structure of the set of input data; and
generating the first framework object by creating a data object comprising the set of input data, structure data corresponding to the determined structure, and at least one association with the set of functions.

18. The apparatus of claim 17, wherein the structure of the set of input data is determined based on one or more dimension values explicitly specified during a definition of the first framework object.

19. A computer program product comprising at least one computer-readable storage medium bearing computer program instructions embodied therein for use with a computer, the computer program instructions comprising program instructions configured to:
generate a first framework object from a set of input data, the first framework object comprising a first set of data values and a set of structure data defining at least one dimension for formatting the first set of data values, wherein the first framework object is associated with a set of functions for manipulating the first set of data values;
determine an expression to be performed on the first framework object, the expression comprising at least one operator;
select at least one of the set of functions based on the at least one operator; and
evaluate the expression using the selected at least one of the set of functions to manipulate the first set of data values to produce an expression result.

20. The computer readable medium of claim 19, wherein the expression further comprises an identification of a second framework object, and wherein the selected at least one of the set of functions further manipulates a second set of data values associated with the second framework object to produce the expression result.
